(19) United States
(12) Patent Application Publication
(10) Pub. No.: US 2022/0207941 A1
(43) Pub. Date: Jun. 30, 2022

(54) Machine lock

(71) Applicant: John Pal, JR., Petersburg, KY (US)

(72) Inventor: John Pal, JR., Petersburg, KY (US)

(21) Appl. No.: 16/974,309

(22) Filed: Dec. 28, 2020

(51) Int. Cl. G07C 9/20; G07C 9/00; G07C 13/00; E05B 65/00; E05B 35/12

(52) U.S. Cl. CPC G07C 9/20; G07C 9/00182; E05B 35/12; E05B 65/00; G07C 13/00

(57) ABSTRACT

A machine lock that can be integrated or a separate device for securing any machine including voting election machines or any other security purpose having adaptability to be used with any and all devices and machines. The machine lock can also be used with an machine involved in the voting process (or any other type of machine not involved with the voting process), including but not limited to ballot openers, poll books, optical scanners, tabulators, printers, electronic voting management systems, universal voting systems, folded ballot processing machines, and voter registration management equipment. It will require two or more opposed observers, each with a unique way to open two or more locks, with a mechanical keys, keypads, combination locks, cards (including magnetic and all other types), or cell phones, remote controls or by any other method to turn on the machine, or to turn on certain functions within any machine.

### BACKGROUND OF THE INVENTION

Historically the problem with fraud in elections has been not having two opposed party's observing the functions of many of the voting machines. Most of the machines can be turned on freely by the poll workers without any supervision or without two opposed parties observing the operation of the machine and fraud can occur. This present invention will solve this problem, in that you need two or more opposed observers, each with a unique way to open two or more locks, with a mechanical key, keypad, combination lock, card (including magnetic and all other types), or cell phone, remote controls (including but not limited to radio waves, sound waves, infrared waves, or any type of wave) or by any other method to turn on the machine, or to turn on certain functions within any machine. This invention can also apply to any machine that is not involved with the voting process. This invention can be used in a multitude of situations not mentioned here.

### BRIEF SUMMARY OF THE INVENTION

Disputes of fraud in elections have haunted elections for many years with one party or the other secretly in the back room turning on voting machines and adding ballots or ballot counts to the voting machine. This invention will overcome these weaknesses in our voting system by requiring two or more opposed parties to be present to turn on the machine or to turn on certain functions of the machine.

This voting machine lock can be built into any existing voting machine, or could be a separate component attached to an existing voting machine by any connection means, including but not limited to connectors, hardwired, cell phone or remote control.

The voting machine lock consist of at least two locks and requires the possession of two unique means of opening each of the two locks. The most common form of opening a lock would be possession of two differently cut mechanical keys, a mechanical keypad, combination locks, cards that a card reader would read (including magnetic and all other types), or cell phones, remote controls (including but not limited to radio waves, sound waves, infrared or any type of wave), or by any other means to turn on the machine, or to turn on certain functions within the machine.

The voting machine lock can also consist of any type of connection, including but not limited to mechanical or electrical switch or connector, including but not limited to a solenoid (including magnetic), electronic switch (fet: field effect transistor, for example), waves (including but not limited to radio waves, sound waves, infrared waves) or by any means that will open both the locks to complete or provide electric continuity to the same series circuit or different circuits in two places, thereby completing the circuit(s) when both locks are activated.

Within any voting machine or any machine, the circuit to be controlled could be any circuit. If control of disabling the power to the machine is desired, then the circuit disabled could be the supply voltage circuit. If the control of disabling a higher level function of the machine is desired, then the for example, the circuit supplying voltage to the cpu (central processing unit) could be disabled.

### BRIEF DESCRIPTION OF THE DRAWINGS

FIG. 1 sets forth a view in elevation of the machine lock as integrated into any voting machine or other machine with two mechanical locks. The two locks shown are installed into the container of any voting machine or other machine. Internally the wires or by other means will be connected inside the voting machine or other machine.

FIG. 2 sets forth a view in elevation of the machine lock as integrated into any voting machine or other machine with two numerical keypads. The two locks shown are installed into the container of any voting machine or other machine. Internally the wires or by other means will be connected inside the voting machine or other machine.

FIG. 3 sets forth a view in elevation of the machine lock as a separate component with two mechanical locks. Externally the wires would connect to the voting machine or other machine or by other means. Also displayed in a connector that will connect into the separate voting machine or other machine.

FIG. 4 sets forth a view in elevation of the machine lock as a separate component shown with a card reader. Externally the wires would connect to the voting machine or other machine or by other means. Also displayed are wires without a connector because in this configuration the wires will be hard wired into the separate voting machine or other machine.

FIG. 5 sets forth a schematic of the machine lock with two mechanical locks. The two locks are shown and each are connected to its own contact or switch and when both switches are connected it will complete the series circuit. The series circuit can be connected to interrupt any process in any machine or voting machine and is shown by the square boxes which could be any process but are shown as source of process power and any process.

FIG. 6 sets forth a schematic of the machine lock with two card readers. The two card reader locks are shown each are connected to its own contact or switch and when both switches are connected it will complete the series circuit. The series circuit can be connected to interrupt any process in any machine or voting machine and is shown by the square boxes which could be any process but are shown as source of power and power supplied to machine.

FIG. 7 sets forth a view in elevation of the two mechanical keys required to successfully turn on the circuit of the machine lock. The two cards are also shown that are required to successfully open the card reader to successfully turn on the circuit of the machine lock. There are other ways not shown here that may be used to turn on the circuit.

FIG. 8 set forth a view in elevation of the cell phone that could be used to successfully turn on the circuit of the machine lock. A remote control is also shown which also could be used to turn on the circuit of the machine lock.

### DETAILED DESCRIPTION OF THE INVENTION

The drawings and description contained are for purposes of illustrating the invention only and not for purposes of limiting same.

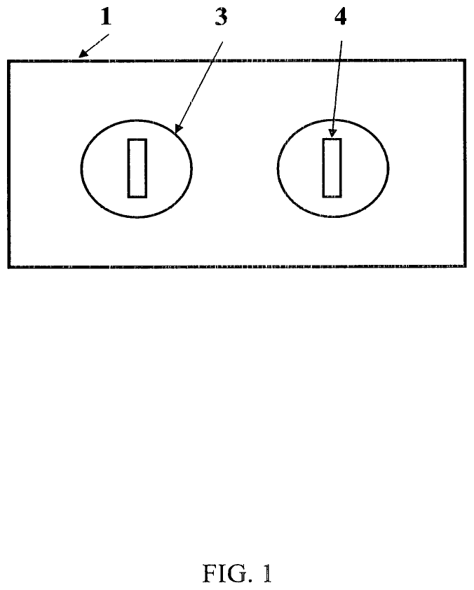

FIG. 1 Displays the elevation view of the machine lock integrated into a voting machine or any other machine. Number 1 indicates the voting or other machine that the voting machine locks would be built into. Number 3 indicates the housing for the lock. Number 4 indicates the key slots for the mechanical keys that will actuate the circuit within.

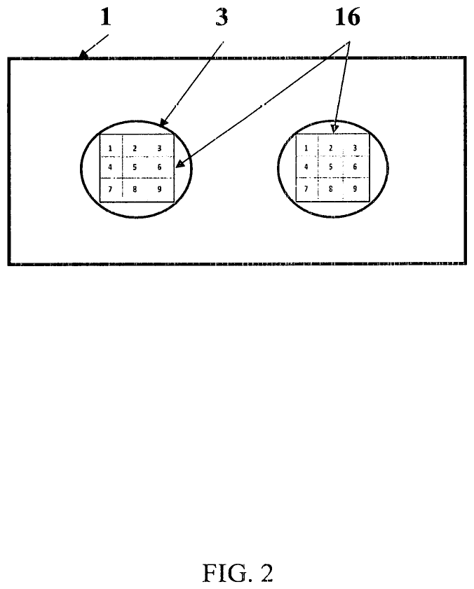

FIG. 2 Displays the elevation view of the machine lock integrated into a voting machine or any other machine. Number 1 indicates the voting or other machine that the voting machine locks would be built into. Number 3 indicates the housing for the lock. Number 16 indicates the numeric key pads that will actuate the circuit within.

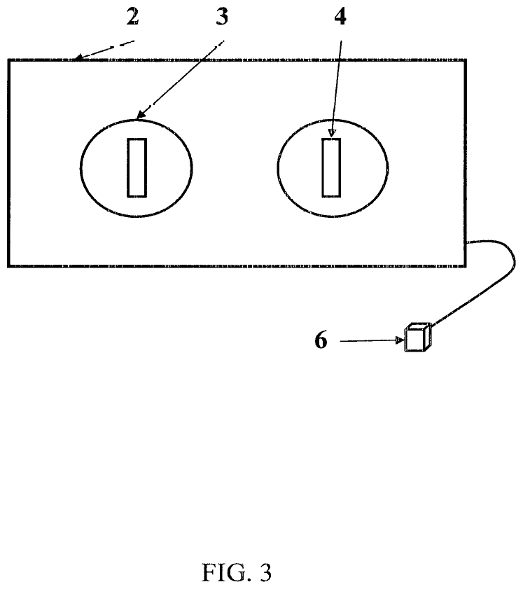

FIG. 3 Displays the elevation view of the machine lock that is a separate component 2 that can be connected by connector 6 to a separate voting machine or other machine. Number 3 indicates the housing for the lock. Number 4 indicates the key slots for the mechanical keys that will actuate the circuit within.

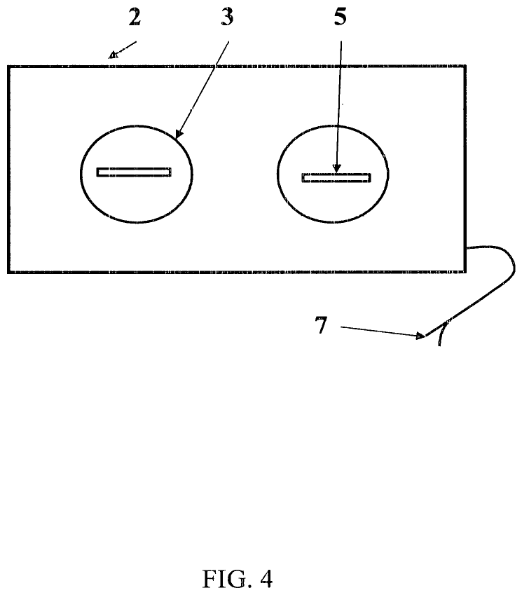

FIG. 4 Displays the elevation view of the machine lock that is a separate component 2 that can be connected by hard wire 7 to a separate voting machine or other machine. No 3 indicates the housing for the lock. Number 5 indicates the card reader slots for the insertion of cards that will actuate the circuit within.

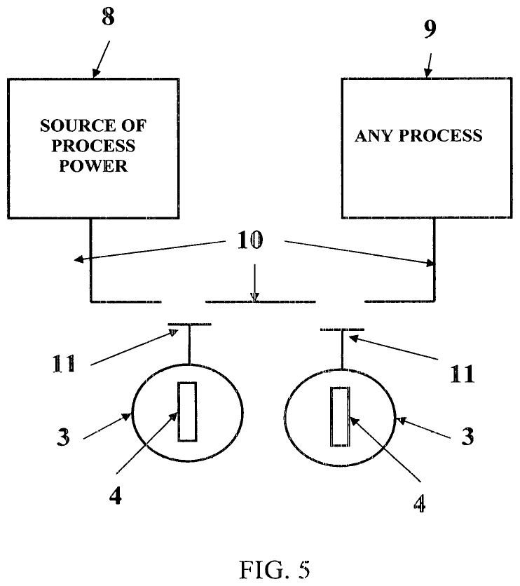

FIG. 5 Displays the schematic of the machine lock. Number 3 indicates the housing for the lock (not shown in voting machine or in a separate component). Number 4 indicates the key slots for the mechanical keys that will actuate the circuit within. Number 11 indicates both of the contacts , switches, solenoids, or any other connections that are activated by the mechanical keys 12 (not shown in this drawing) or the cards 13 (not shown in this drawing), or by any other manner, that will complete the series circuit that will turn on or complete any circuit in the voting machine or any other machine. Number 10 is the series circuit connected across any process in the voting machine or machine. Number 8 is source of the process power in the machine that you want to connect across this circuit. Number 9 is the termination of any process of the series circuit in the machine that you want to connect in a circuit.

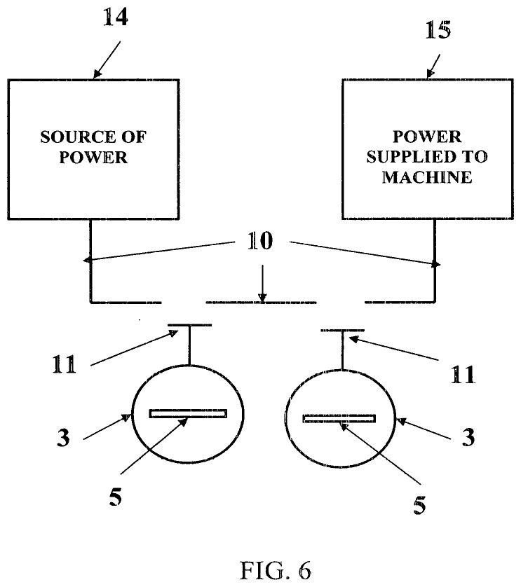

FIG. 6 Displays the schematic of the machine lock. Number 3 indicates the housing for the lock (not shown in voting machine or in a separate component). Number 5 indicates the card reader slots for the cards that will actuate the circuit within. Number 11 indicates both of the contacts switches, solenoids, or any other connections that are activated by the mechanical keys 12 (not shown in this drawing) or the cards 13 (not shown in this drawing), or by any other manner, that will complete the series circuit that turn the voting machine or a circuit in the voting machine, or any other machine. Number 10 is the series circuit connected across any process in the voting machine or machine. Number 14 is any process in the machine that you want to connect across this circuit but in this case, it is shown as the source of power. Number 15 is the termination of the series circuit of any process in the machine that you want to connect across this circuit but in this case as shown as the power supplied to machine.

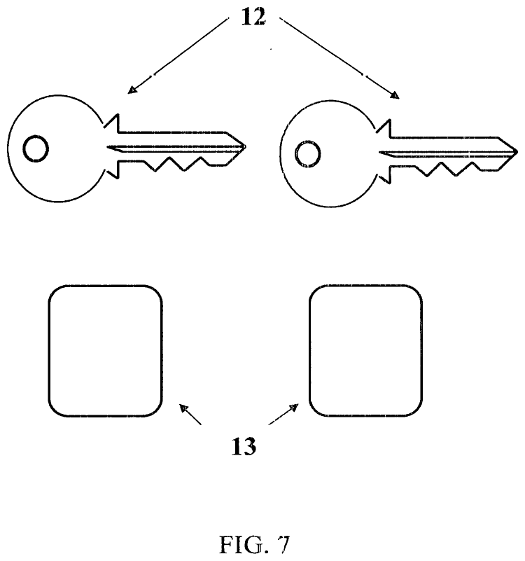

FIG. 7 Number 12 shows the two mechanical keys that can actuate the circuit. Number 13 shows the two cards that actuate the circuit. Any other method not shown here of actuating and completing the series switches is also acceptable.

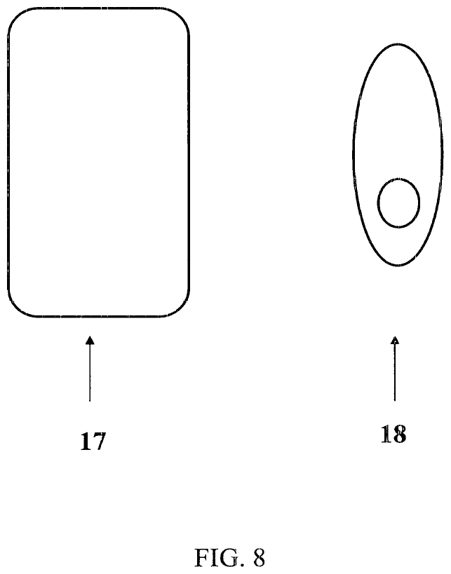

FIG. 8 Number 17 shows a cell phone that can actuate the circuit. Number 18 shows a remote control that can actuate the circuit. Any other method not shown here of actuating and completing the series switches is also acceptable.

What is claimed is:

1. A machine lock component comprising of an integrated and/or separate component that prevents operation of any machine, including but not limited to any voting machine or any machine associated with the voting process, unless unlocked by any two or more different means, including but not limited to two or more mechanical keys, two or more keypads, two or more combination locks, two or more cards that can be read by a card reader (including but not limited to magnetic and all other types), two or more cell phones, two or more remote controls (including but not limited to radio waves, sound waves, infrared waves or any other type of wave) or by any other method, that will unlock an electronic circuit by providing electric continuity by any means, including but not limited to contacts, switches or by any mechanical means, electrical means, or by waves (electromagnetic, radio waves, sound waves, infrared waves or any other type of wave) or a combination of these methods, including but not limited to a solenoid (including magnetic), electronic switch (fet: field effect transistor, for example), waves (including but not limited to radio waves, sound waves, infrared waves) or by any means that will open both locks to complete or provide electric continuity to the same series circuit or different circuits in two or more places, thereby completing the circuit(s) when both locks are activated that will allow the machine to turn on and/or allow any of the specific functions on the machine to work.

2. A machine lock component according to claim 1, wherein the machine locks can contained in a separate unit which can be, but not limited to hard wired, connected with any type of connector into the machine, transmitted to the machine from, but not limited to cell phone or remote control, or be built into the machine and can be connected by, but not limited to, by hard wire, connector or transmitted to other parts of the machine.

3. A machine lock component according to claim 1, wherein there can be two or more locks in the component and two or more contacts in the circuit.

4. A machine lock component according to claim 1, wherein the machine locks can be opened by, but not limited to, mechanical keys, keypads, combination locks, cards in a card reader (including but not limited to magnetic and all other types), cell phones, remote controls (including but not limited to radio waves, sound waves, infrared waves or any type of wave) or can be opened by any other manner.

5. A machine lock component according to claim 1, wherein the contacts can be any type of contact providing electrical continuity, including but not limited to contacts, switches or by any mechanical means, electrical means, or by waves (electromagnetic, radio waves, sound waves, infrared waves or any other type of wave) or a combination of these methods, including but not limited to a solenoid (including magnetic), electronic switch (fet: field effect transistor, for example), waves (including but not limited to radio waves, sound waves, infrared waves or any other type of wave) or by any means that will open both locks to complete or provide electric continuity.

6. A machine lock component according to claim 1, where the circuit can be any series circuit or any other circuit in any machine.

7. A machine lock component according to claim 1, where the circuit turned on by actuating both of the locks can be any process in any machine, including but not limited to higher level process or supplying power to the machine.
